(19) United States
(12) Patent Application Publication
(10) Pub. No.: US 2017/0145300 A1
(43) Pub. Date: May 25, 2017

(54) PROPPANT SUSPENSION IN HYDRAULIC FRACTURING

(71) Applicant: Halliburton Energy Services, Inc., Houston, TX (US)

(72) Inventors: Zheng LU, Kingwood, TX (US); Tingji TANG, Spring, TX (US); Humberto Almeida OLIVEIRA, Lagoa Santa, Minas Gerais (BR)

(21) Appl. No.: 15/323,367

(22) PCT Filed: Aug. 28, 2014
(86) PCT No.: PCT/US14/53104

§ 371 Date: Dec. 30, 2016

(51) Int. Cl. C09K 8/80; E21B 43/267; E21B 43/26

(52) U.S. Cl. CPC C09K 8/80; E21B 43/26; E21B 43/267

(57) ABSTRACT

Proppants for use in subterranean formations and methods for fracturing a subterranean formation penetrated by a wellbore are provided. The proppant material comprises a particulate body having a hydrophobic surface. The method involves introducing a plurality of the particulate bodies into an aqueous fluid to produce a fracturing fluid. Subsequently, the fracturing fluid is introduced into the wellbore at or above a pressure sufficient to create or enhance at least one fracture in the subterranean formation. The proppant material has an increased buoyance factor within the aqueous fluid than a similar proppant material without the hydrophobic surface.

### FIELD

This disclosure relates generally to systems and methods for fracturing technologies. More specifically, this disclosure relates to proppants and their use used in fracturing operations.

### BACKGROUND

In the process of acquiring oil and/or gas from a well, it is often necessary to stimulate the flow of hydrocarbons via hydraulic fracturing. The term “fracturing” refers to the method of pumping a fluid into a well until the pressure increases to a level that is sufficient to fracture the subterranean geological formations containing the entrapped materials. This process results in cracks and breaks that disrupt the underlying layer to allow the hydrocarbon product to be carried to the wellbore at a significantly higher rate. Unless the pressure is maintained, however, the newly formed openings close. In order to open a path and maintain it, a propping agent or “proppant” is injected along with the hydraulic fluid to create the support needed to preserve the opening. As the fissure is formed, the proppants are delivered in a slurry where, upon release of the hydraulic pressure, the proppants form a pack or a prop that serves to hold open the fractures.

To accomplish the placement of the proppants inside the fracture, these particles are suspended in a fluid that is then pumped to its subterranean destination. To prevent the particles from settling, a high viscosity fluid is often required to suspend them. The viscosity of the fluid is typically managed by addition of synthetic or naturally-based polymers.

Two important properties of proppants are crush strength and density. High crush strength can be desirable for use in deeper fractures where pressures are greater, e.g., greater than about 2500 psi. As the relative strength of the various materials increases, so too have the respective particle densities. Unfortunately, higher density particles are more difficult to suspend in the fluid, generally, requiring increasing the viscosity of the fracturing fluid; however, at some point, increasing the viscosity of the fluid can be detrimental to the fracking process.

### BRIEF DESCRIPTION OF THE DRAWINGS

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

FIG. 3 is an illustration of air bubbles trapped on the surface of a proppant particle.

FIG. 4 is a chart illustrating the contact angles for bauxite proppants having different surface hydrophobic-functional groups.

FIG. 5 is a chart illustrating the crush strength for bauxite proppants having different surface hydrophobic-functional groups.

### DETAILED DESCRIPTION

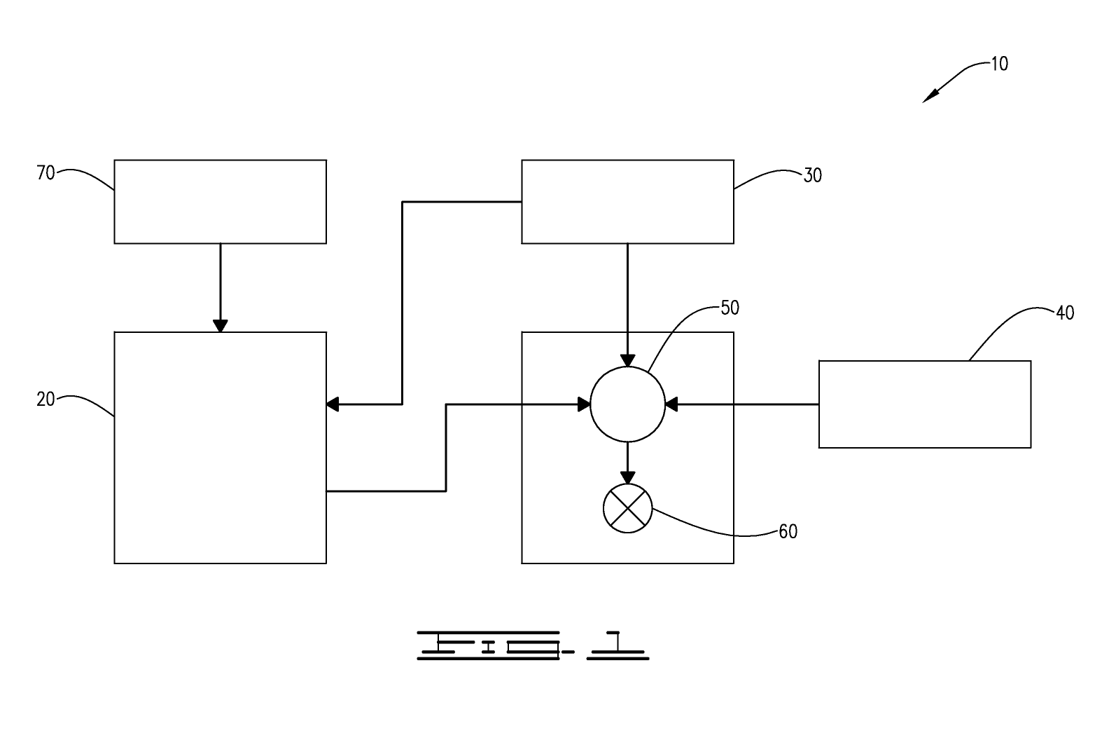

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor (or gelling agent) with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant for combination with the fracturing fluid. The system may also include additive source 70 that provides one or more additives (e.g., gelling agents, weighting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 to source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppants at other times, and combinations of those components at yet other times.

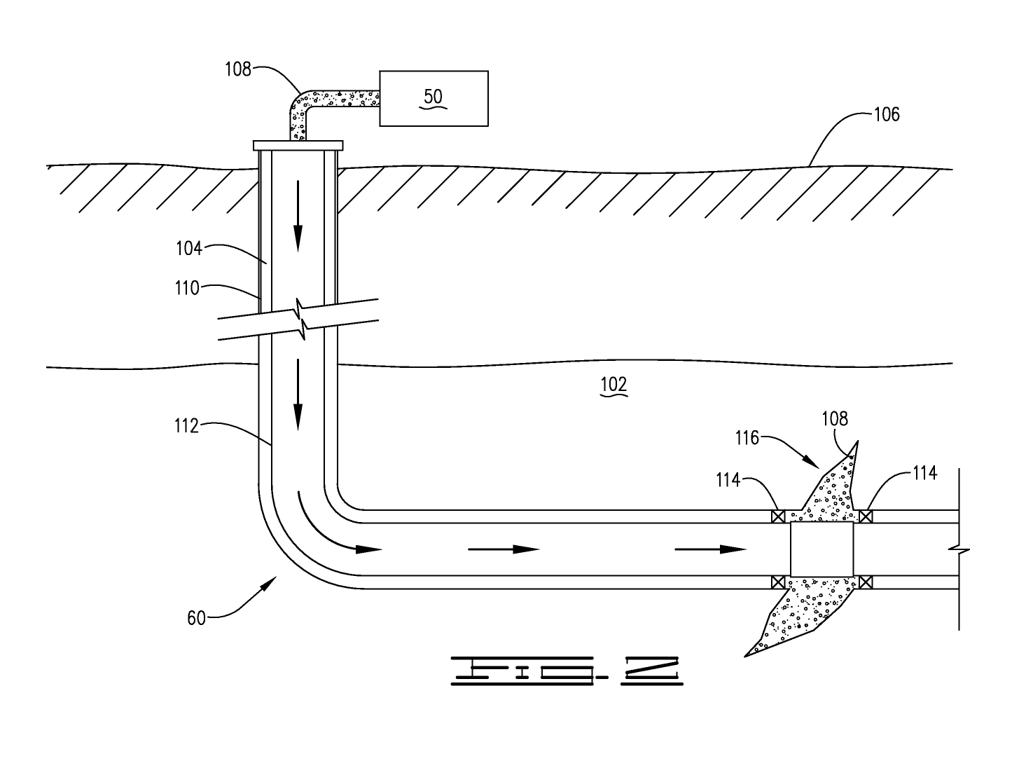

FIG. 2 shows the well 60 during a fracturing operation in a portion of a subterranean formation of interest 102 surrounding a wellbore 104. The wellbore 104 extends from the surface 106, and the fracturing fluid 108 is applied to a portion of the subterranean formation 102 surrounding the horizontal portion of the wellbore. Although shown as vertical deviating to horizontal, the wellbore 104 may include horizontal, vertical, slant, curved, and other types of wellbore geometries and orientations, and the fracturing treatment may be applied to a subterranean zone surrounding any portion of the wellbore. The wellbore 104 can include a casing 110 that is cemented or otherwise secured to the wellbore wall. The wellbore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro-jetting and/or other tools.

The well is shown with a work string 112 depending from the surface 106 into the wellbore 104. The pump and blender system 50 is coupled with a work string 112 to pump the fracturing fluid 108 into the wellbore 104. The working string 112 may include coiled tubing, jointed pipe, and/or other structures that allow fluid to flow into the wellbore 104. The working string 112 can include flow control devices, bypass valves, ports, and/or other tools or well devices that control a flow of fluid from the interior of the working string 112 into the subterranean zone 102. For example, the working string 112 may include ports adjacent the wellbore wall to communicate the fracturing fluid 108 directly into the subterranean formation 102, and/or the working string 112 may include ports that are spaced apart from the wellbore wall to communicate the fracturing fluid 108 into an annulus in the wellbore between the working string 112 and the wellbore wall.

The working string 112 and/or the wellbore 104 may include one or more sets of packers 114 that seal the annulus between the working string 112 and wellbore 104 to define an interval of the wellbore 104 into which the fracturing fluid 108 will be pumped. FIG. 2 shows two packers 114, one defining an uphole boundary of the interval and one defining the downhole end of the interval. When the fracturing fluid 108 is introduced into wellbore 104 (e.g., in FIG. 2, the area of the wellbore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the wellbore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another; any pumps, compressors, or motors used to drive the compositions into motion; any valves or related joints used to regulate the pressure or flow rate of the compositions; and any sensors (i.e., pressure and temperature), gauges, and/or combinations thereof, and the like.

Turning now to one embodiment, there is provided a proppant material having a hydrophobic surface. Generally, the surface of proppant materials is hydrophilic. For example, ceramic particles generally have oxygen or hydroxide group exposed at the surface; thus, providing for a hydrophilic surface. The present embodiment takes advantage of these hydrophilic functional groups by exchanging them with hydrophobic functional groups. That is, a hydrophobic group is reacted with the surface oxygen or hydroxide group to either replace them by directly bonding the hydrophobic group with a metal component of the proppant or by bonding the hydrophobic group to the oxygen.

A proppant having a hydrophobic surface in accordance with the invention enables the use of dense proppants having high crush strength, which still adequately suspend in the aqueous treatment fluid used to perform fracturing and transport the proppant to the fracture site. That is, proppants having crush strength of at least 4000 psi, more typically at least 8,000 psi and even greater than 12,000 psi, can still be adequately suspended in the aqueous treatment fluid despite having specific gravities greater than 1.0 g/cc or even greater than 2.0 g/cc. The proppants having a hydrophobic surface due to hydrophobic functional groups will not be wetted by fluid, and air bubbles near to the surface will be trapped by the hydrophobic functional groups. These air bubbles provide extra buoyancy to the proppant particle and help to improve the suspension and transportation. Additionally, the hydrophobic functional groups can additionally increase proppant strength providing it with greater crush strength than use of the unmodified proppant having hydrophilic functional groups without substantially increasing the proppant's density. The crush strength of the modified proppant will generally be increased by 10% or more over the crush strength of the unmodified proppant. Additionally, the crush strength can be increased by more than 12% or more than 15% greater than for the unmodified proppant.

The resistance of the current hydrophobic proppant to wetting provides for greater protection against scaling than hydrophilic proppant surfaces. Proppant scaling is a geochemical reaction that occurs between ceramic proppants and the formation in a wet, hot downhole fracture environment. While this reaction normally happens slowly in shallower formations, it accelerates under the higher pressures and temperatures. The result of proppant scaling is a severe loss of proppant pack porosity and permeability as fines and debris are created in the proppant pack. The current hydrophobic proppants drastically reduce the impact of downhole proppant scaling, resulting in improved fracture flow capacity and significantly higher long-term productivity. In this manner, the current hydrophobic proppant has more enduring conductivity. Conductivity is a measure of how easily fluids can flow through proppant and generally the higher the conductivity, the better.

The proppant base comprises a solid particulate material such as sand or ceramic materials. The proppant base should be particles having surface oxide or hydroxide molecules. Preferred proppant bases are metal oxides and bauxites. The metal oxides will typically be in the form of sand, quartz particles, or ceramic particles and include silicon dioxide, aluminum oxide, zinc oxide and similar. Ceramics made from metal oxides generally have surface hydroxides, which are especially well suited for exchange, as described below.

Because of the surface oxides and hydroxides, the proppant base will be hydrophilic. To provide for a hydrophobic surface, at least a portion of these oxides and hydroxides are exchanged with hydrophobic functional groups and, preferably, superhydrophobic functional groups to form the hydrophobic proppant material. “Exchange” as used herein referrers to chemically reacting the hydrophobic functional group with the metal oxide or metal hydroxide at the surface such that the hydrophobic functional group chemically bonds to the oxygen or replaces the oxide or hydroxide by direct chemical bonding with the metal. Thus, the hydrophobic functional group is grafted or chemically bonded at the oxide sites or hydroxide sites. This chemical bonding of hydrophobic functional groups is distinguishable from processes that provide for hydrophobic coatings on particles in that coatings do not provide with chemical bonding to the metal oxide but rather only provide for a physical interaction. The chemical bonding of the current hydrophobic functional groups provides for a much stronger interaction between the proppant surface and the hydrophobic functional groups than prior coatings relying on physical interactions. Accordingly, the current hydrophobic proppants have greater resistance to physical forces, such as shear, solvation and melting, which tend to separate coatings from proppants.

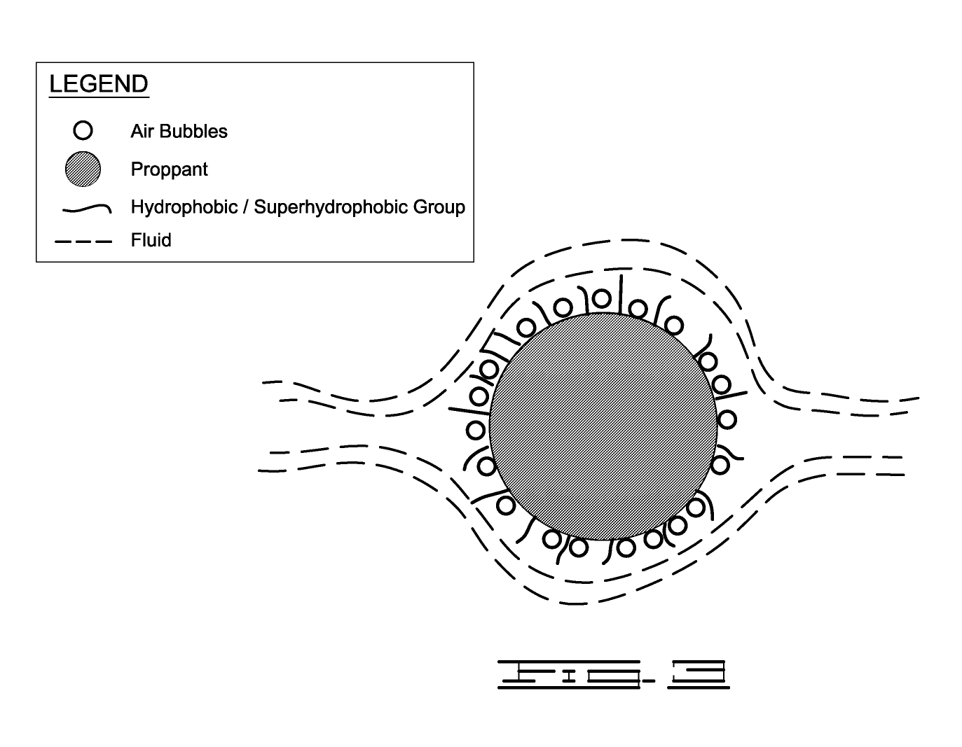

Additionally, the hydrophobicity of the surface modified proppants will have a higher tendency to entrap air bubbles during the slurry blending process, which leads to a higher apparent buoyance factor than for a hydrophilic proppant or a proppant without the surface modification. FIG. 3 illustrates the air bubbles trapped on the surface of the proppant when the surface modified proppant is in an aqueous fluid.

The hydrophobic functional group will typically be a hydrophobic organic functional group preferably having carbon chains of at least 2 carbon atoms and more preferably at least 4 carbon atoms. While generally longer carbon chains will be more effective for buoyance, it is presently preferred that the organic functional groups will be at most 16 carbon atoms due to the lower solubility in the solution. The hydrophobic functional group can also be selected from other hydrophobic compounds capable of exchanging with oxide or hydroxide functional groups, for example the hydrophobic functional group can be a silane or an organosilane. Typically, the hydrophobic functional groups will be derived from an alkane, an alkene, and alkyne, a cycloalkane, a cycloalkene, a cycloalkyne, an aromatic ring, a silane or derivatives thereof, such as alkyl halides. Accordingly, the hydrophobic functional group can be selected from alkyl and derivatives thereof. Halide derivatives are preferred, such as fluoride derivatives. Additionally, the hydrophobic functional group can be alkly phosphonic acid, silanes and fluorinated silanes. Certain superhydrophobic chemicals can be used to provide the hydrophobic functional groups. One such superhydrophobic chemical is sold under the name HydroFoe by Lotus Leaf coatings. In one preferred embodiment, the hydrophobic functional group can be selected from the group consisting of alkyl, aryl, silanes, alkyl phosphonic acid, perfluoroalkyl, derivatives thereof, and mixtures thereof.

The hydrophobic functional group exchange can be carried out by various exchange methods known in the art. For example, bonding of the hydrophobic functional group to the proppant base can occur by a condensation reaction of a hydrolizable hydrophobic functional group with hydroxide groups on the surface of the proppant base. This results in covalent bonding of the hydrophobic functional group on the surface of the proppant base through an oxygen bridge. Phosphonic acids can be grafted by coordination or iono-covalent interaction of a phosphonic acid with a metal oxide surface of a proppant base. Alternatively, the hydrophobic functional group can be chemically bonded to the metal of the metal oxide by a process similar to that disclosed in US 2012/0012528 A1 for membranes, where direct covalent binding of organic functional groups is achieved by allowing a pre-treated matrix to react with organometallic reagents in the presence of a suitable solvent.

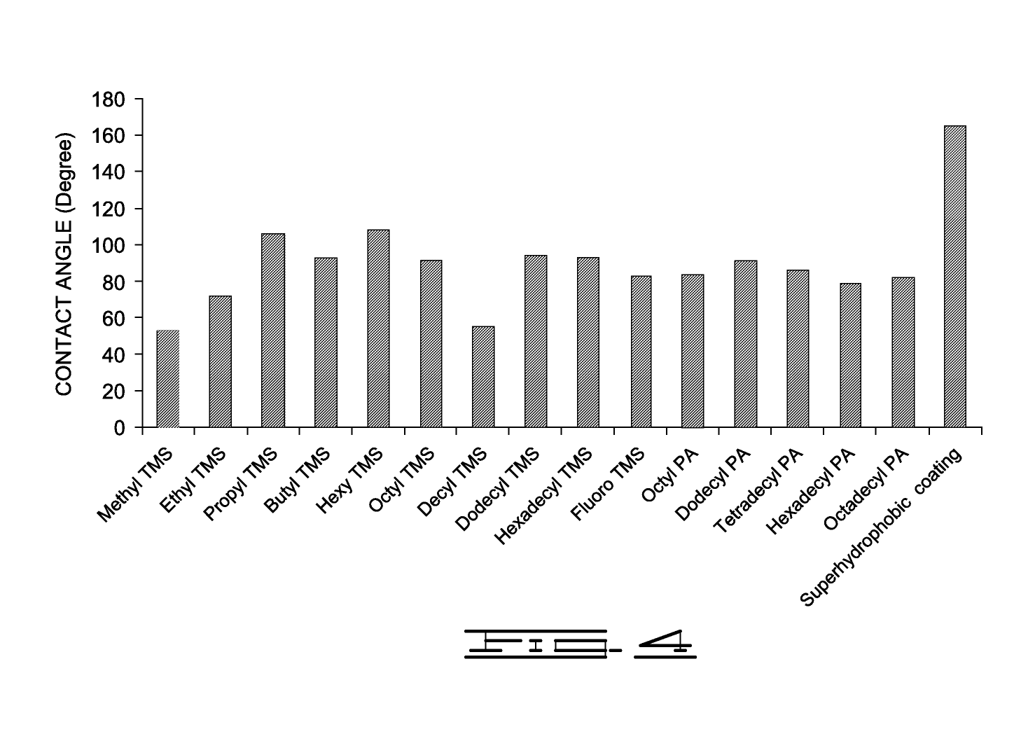

When the surface of a proppant is modified to include hydrophobic functional groups in accordance with the above discussion, the proppant has a hydrophobic interaction with aqueous fluid. “Contact angle” is a measurement quantifying the wettability of a solid surface by a liquid (e.g., water for hydrophobicity measurements). An unmodified bauxite proppant has a contact angle of about 10° or less. FIG. 4 illustrates the contact angle for surface modified bauxite proppants. The bauxite proppant is sold under the trademark Sinterball by Mineracao Curimbaba, Ltda. The contact angle was measure for bauxite proppants modified with various hydrophobic functional groups. In FIG. 4, “TMS” stands for trimethoxy silane and “PA” stands for phosphonic acid. The superhydrophobic coating is a coating sold under the trademark HydroFoe by Lotus Leaf. The superhydrophobic coating was chemically bonded to the proppant surface and not used as a coating material having only a physical interaction. As can be seen from FIG. 4, all the surfaced modified proppants have a significantly higher contact angle than an unmodified bauxite proppant. This represents that the surface modified proppants are significantly hydrophobic.

The resulting hydrophobic proppant can be used in a method of fracturing a subterranean formation penetrated by a wellbore. Suitable hydrophobic proppants in accordance with the above description can be premade at a manufacturing facility prior to delivery and use at the wellsite. Alternatively, the proppants at the wellsite can be treated to incorporate surface hydrophobic functional groups at the wellsite where the fracturing treatment will occur, which means making the hydrophobically modified proppants on the fly. Typically, a plurality of hydrophobic proppant particles or proppant agents is introduced into an aqueous fluid to produce a fracturing fluid. Subsequently, the resulting fracturing fluid is introduced into the wellbore at or above a pressure sufficient to create or enhance at least one fracture in the subterranean formation. This process results in cracks that disrupt the underlying layer to allow the hydrocarbon product to be carried to the wellbore at a significantly higher rate. As the fissure is formed, the proppants are delivered in the fracturing fluid so that, upon release of the hydraulic pressure, the proppant particles form a pack or a prop that serves to hold open the fractures.

The proppant agents are suspended in the aqueous fluid such that they will be carried along with the fluid without substantially settling until after the fracture site is reached. The hydrophobic functional groups on the surface of the proppant particles trap air when the proppant agent is introduced into the aqueous fluid. The air increases the buoyancy of the proppant in the aqueous fluid such that the proppant is suspended in the aqueous fluid.

### EXAMPLES

The following example is provided to illustrate the invention. The example is not intended and should not be taken to limit, modify or define the scope of the present invention in any manner.

A sintered bauxite proppant was obtained. A first portion was used as control sample with no surface modification. Six other portions were treated to modify the surface of the proppant by exchanging hydrophobic functional groups with hydroxyl groups on the surface.

The exchange was with the following compounds: n-octyl trimethoxysilane, diphenyl dimethoxysilane, cyclohexyl trimethoxysilane, di-n-octyl dimethyl chlorosilane, bis(3-trimethoxysilane)propyl ethylenediamine. The silanes were first hydrolyzed in acid water/alcohol (ethanol or isopropyl alcohol) solution at a concentration of 1 mg/L. Then the hydrolyzed silane solution was dripped or sprayed on the proppant so as to initiate the functional group exchange.

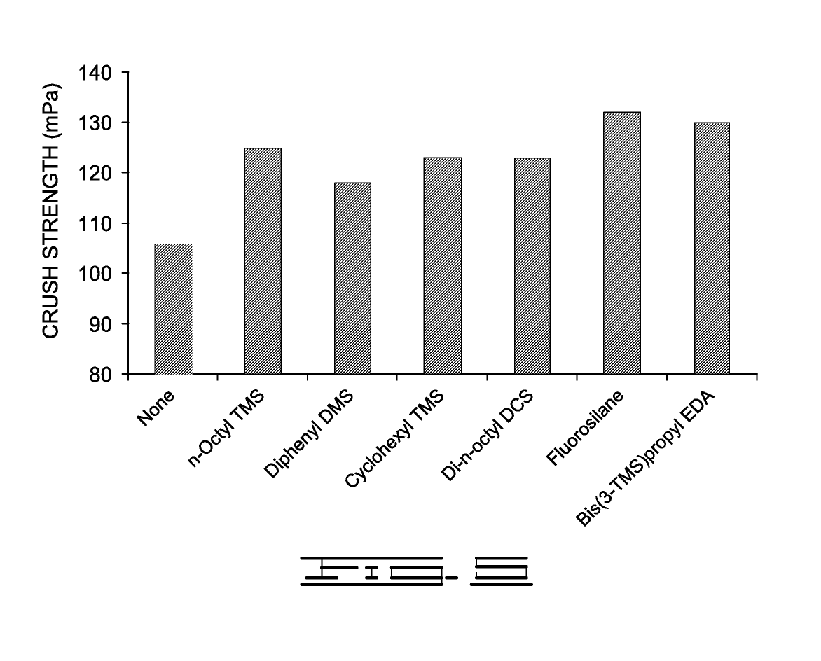

Each portion was tested for crush strength by a force lever tester manufactured by Mark 10. The results are shown in FIG. 5 where it can be seen that all the hydrophobic proppants samples had increased crush strength over the control sample.

Exemplary embodiments that are in accordance with the above description include a proppant material comprising a particle that comprises a compound selected from the group consisting of metal oxides, metal hydroxides and mixtures thereof. The particle has a hydrophobic surface wherein surface metals are bonded to a hydrophobic functional group. The hydrophobic surface can be produced by grafting hydrophobic functional groups at surface hydroxyl groups sites and oxide sites. Alternatively, the hydrophobic surface can be produced by exchanging surface hydroxyl groups with hydrophobic functional groups. The hydrophobic functional group can be selected from the group consisting of alkyl, aryl, silanes, alkyl phosphonic acid, perfluoroalkyl, derivatives thereof, and mixtures thereof. The particle can comprise a compound selected from the group consisting of metal oxides and bauxites.

In a further aspect, the hydrophobic surface traps air when the proppant material is introduced into an aqueous fluid. The air increases the buoyancy of the proppant in the aqueous fluid such that the proppant is suspended in the aqueous fluid. In a further embodiment, the surface is superhydrophobic. Also in another aspect, the proppant material has a crush strength at least 10% greater than the particle not modified by the hydrophobic functional groups. Additionally, the crush strength can be at least 12% greater or 15% greater than the particle not modified by the hydrophobic functional groups.

In another exemplary embodiment, there is provided a method of fracturing a subterranean formation penetrated by a wellbore. The method comprises providing a fracturing fluid comprising a plurality of proppant agents and an aqueous fluid. Each proppant agent comprises a particle that comprises a compound selected from the group consisting of metal oxides, metal hydroxides and mixtures thereof. The particle has a hydrophobic surface wherein surface metals are bonded to a hydrophobic functional group. The method further comprises introducing the fracturing fluid into the wellbore at or above a pressure sufficient to create or enhance at least one fracture in the subterranean formation. In the method, the hydrophobic surface traps air when the proppant agent is introduced into the aqueous fluid. The air increases the buoyancy of the proppant in the aqueous fluid such that the proppant is suspended in the aqueous fluid.

The hydrophobic surface can be made by the steps of obtaining a ceramic particle having surface hydroxyl groups and exchanging the surface hydroxyl groups with hydrophobic functional groups.

Additionally, the method can further comprise mixing the fracturing fluid using mixing equipment. The method can also comprise introducing the fracturing fluid into a subterranean formation using one or more pumps.

Therefore, the present invention is well adapted to attain the ends and advantages mentioned, as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified, and all such variations are considered within the scope and spirit of the present invention. While compositions and methods are described in terms of “comprising,” “containing,” “having,” or “including” various components or steps, the compositions and methods can also “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

1. A proppant material comprising a particle that comprises a compound selected from the group consisting of metal oxides, metal hydroxides and mixtures thereof, said particle having a hydrophobic surface wherein surface metals are bonded to a hydrophobic functional group.

2. The proppant material of claim 1, wherein said surface is superhydrophobic.

3. The proppant material of claim 1, wherein said hydrophobic surface is produced by grafting hydrophobic functional groups at surface hydroxyl groups sites and oxide sites.

4. The proppant material of claim 1, wherein said hydrophobic surface is produced by exchanging surface hydroxyl groups with hydrophobic functional groups.

5. The proppant material of claim 1, wherein said hydrophobic functional group is selected from the group consisting of alkyl, aryl, silanes, alkyl phosphonic acid, perfluoroalkyl, derivatives thereof, and mixtures thereof.

6. The proppant material of claim 1, wherein said hydrophobic surface traps air when said proppant material is introduced into an aqueous fluid.

7. The proppant material of claim 6, wherein said air increases the buoyancy of the proppant in said aqueous fluid such that said proppant is suspended in said aqueous fluid.

8. The proppant material of claim 1, wherein said proppant material has a crush strength at least 10% greater than said particle not modified by said hydrophobic functional groups.

9. The proppant material of claim 8, wherein said hydrophobic surface is produced on said particle by exchanging surface hydroxyl groups with hydrophobic functional groups.

10. The proppant material of claim 9, wherein said hydrophobic surface traps air when said proppant material is introduced into an aqueous fluid wherein said air increases the buoyancy of said proppant in said aqueous fluid such that said proppant is suspended in said aqueous fluid.

11. The proppant material of claim 10, wherein said hydrophobic organic functional group is selected from the group consisting of alkyl, aryl, silanes, alkyl phosphonic acid, perfluoroalkyl, derivatives thereof, and mixtures thereof.

12. The proppant material of claim 11, wherein said hydrophobic surface is superhydrophobic.

13. A method of fracturing a subterranean formation penetrated by a wellbore, the method comprising:
providing a fracturing fluid comprising a plurality of proppant agents and an aqueous fluid, wherein each proppant agent comprises a particle that comprises a compound selected from the group consisting of metal oxides, metal hydroxides and mixtures thereof, said particle having a hydrophobic surface wherein surface metals are bonded to a hydrophobic functional group; and
introducing said fracturing fluid into the wellbore at or above a pressure sufficient to create or enhance at least one fracture in the subterranean formation.

14. The method of claim 13, wherein said hydrophobic surface traps air when said proppant agent is introduced into said aqueous fluid wherein said air increases the buoyancy of the proppant in said aqueous fluid such that said proppant is suspended in said aqueous fluid.

15. The method of claim 13, wherein said hydrophobic surface is made by the steps of:
obtaining a ceramic particle having surface hydroxyl groups; and
exchanging said surface hydroxyl groups with hydrophobic functional groups.

16. The method of claim 15, wherein said hydrophobic surface is made at a wellsite where the wellbore is located.

17. The method of claim 15, wherein said hydrophobic surface is made prior to said proppant being delivered to a wellsite where the wellbore is located.

18. The method of claim 15, wherein said hydrophobic functional group is selected from the group consisting of alkyl, aryl, silanes, alkyl phosphonic acid, perfluoroalkyl, derivatives thereof, and mixtures thereof.

19. The method of claim 13, further comprising mixing the fracturing fluid using mixing equipment.

20. The method of claim 13, wherein the fracturing fluid is introduced into the subterranean formation using one or more pumps.
